(19) United States
(12) Patent Application Publication
(10) Pub. No.: US 2025/0265124 A1
(43) Pub. Date: Aug. 21, 2025

(54) MANAGEABLE INPUT/OUTPUT (IO) FOR VOLATILE CONTAINER MEMORY

(71) Applicant: Red Hat, Inc., Raleigh, NC (US)

(72) Inventors: Giuseppe Scrivano, Milan (IT); Michael Tsirkin, Ra'anana (IL)

(21) Appl. No.: 18/442,557

(22) Filed: Feb. 15, 2024

(51) Int. Cl. G06F 9/50; G06F 9/30; G06F 16/176

(52) U.S. Cl. CPC G06F 9/5044; G06F 9/30047; G06F 9/5011; G06F 16/1774

(57) ABSTRACT

Disclosed are techniques for a temporary file system with local memory swapping capabilities. An example method includes receiving a mount request comprising a request to mount a temporary file system for a container. The mount request indicates that the temporary file system is to reside in volatile memory of the container and includes one or more local memory-swapping specifications to be applied to the container. The method also includes receiving write operations addressed to the container. The method also includes determining, by a processing device, whether to initiate local memory swapping for the container by comparing memory usage of the container with a threshold memory usage, and in response to determining to initiate local memory swapping, swapping data from the volatile memory of the container to a local swap file specified by the one or more local memory-swapping specifications included in the mount request.

### TECHNICAL FIELD

Aspects of the present disclosure relate to speedup of build container data access by controlling input/output (IO) generated by the container.

### BACKGROUND

A container orchestration platform is a platform for developing and running containerized applications and may allow applications and the data centers that support them to expand from just a few machines and applications to thousands of machines that serve millions of clients. Container orchestration engines may provide an image-based deployment module for creating containers and may store one or more image files for creating container instances. Many application instances can be running in containers on a single host without visibility into each other's processes, files, network, and so on. Each container may provide a single function (often called a “service”) or component of an application, such as a web server or a database, though containers can be used for arbitrary workloads. One example of a container orchestration platform is the Red Hat™ OpenShift™ platform built around Kubernetes.

To instantiate a new container, the container orchestration system uploads a container image that provides instructions for how to build the container. The container image describes the allocated computing resources and file systems for a container instance to be instantiated, such as the container's operating system, applications to be executed, processing tasks to be handled, etc. During a build of a container image, if a system failure occurs or the build fails for some reason, the build process may be restarted from the beginning in a new container. Accordingly, changes made to the container memory during the failed build may be disregarded. Thus, IO operations for changes in memory during build of a container image such as sync operations or page caching may result in a significant waste of computer resources.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example computing system architecture, in accordance with some embodiments of the present disclosure.

FIG. 2 illustrates an example system for operating a memory swapping technique with a temporary file system, according to some embodiments of the present disclosure.

FIG. 3 is a flow diagram summarizing a method of operating a memory swapping technique for a temporary file system, in accordance with some embodiments of the present disclosure.

FIG. 4 is a block diagram of a system for operating a memory swapping technique for a temporary file system, in accordance with some embodiments of the present disclosure.

FIG. 5 is a block diagram of an example computing device that may perform one or more of the operations described herein, in accordance with some embodiments of the present disclosure.

### DETAILED DESCRIPTION

Processes and applications running on a computer system may make writes to data in the volatile memory (i.e., main memory or system memory) of the computer system. The processes and applications may request an operating system (OS) kernel to save the changes in memory to a non-volatile storage device using one of several synchronization (sync) operations. Synchronizing data to storage may be an expensive operation in terms of compute cycles and resource consumption. As a result, the OS kernel may freeze other system processes to perform the sync operation. In some circumstances, syncing data to storage may not be necessary. Therefore, sync operations performed under these circumstances may utilize resources unnecessarily. For example, during a build of a container image, the changes in memory may be disregarded if the build fails. Thus, sync operations for changes in memory during build of a container image may be excessive since the changes may be disregarded if the build fails or if system failure occurs. Therefore, any additional syncs requested by the container or applications of the container during the build of the container image may result in a significant waste of computer resources.

One technique for reducing unnecessary sync operations is to use a mount option that enables the kernel to ignore syncs to specified file systems mounted by a container. The effect of this mount option is that sync calls received from the container (e.g., fsync/syncfs) are ignored for the files writing to the file system. Accordingly, this mount option keep the container data in volatile memory longer and significantly reduces the number of writes to storage and speeds up build time. However, some container data may still be flushed to storage periodically during the build as a consequence of a background cache management performed by the kernel on a global scale. For example, the kernel may be configured to manage a persistent local cache that can be used by file systems to cache data retrieved over the network to local storage. This background cache management is governed by settings such as a dirty page timeout and dirty page limits, which are described further below. These settings are global settings, which means that they apply to the entire kernel and are not individualized to specific mounts or specific containers. Accordingly, although sync calls received from the container are ignored, the build process may nevertheless result in the generation of significant amount of IO related to the file system.

Aspects of the disclosure address the above-noted and other deficiencies using a mechanism that enables the file system to be maintained in volatile memory during the build as long as there is enough memory available for the container. In accordance with embodiments, the container build is performed using a temporary file system (e.g., tmpfs) that keeps all of its files in volatile memory. Mounting a temporary file system ensures that no files will be created in non-volatile storage, because no syncs will be initiated by the container during the build process, and because the background page caching performed by the kernel would not apply to the temporary file system.

However, using a traditional temporary file system causes all file system data to reside in the container's volatile memory, which may be limited to a maximum allowable size. If the size of the temporary file system exceeds the memory allocated to the container, the build will experience an out-of-memory failure. The address this issue, the temporary file system disclosed herein is configured to support memory swapping at the local level, i.e., at the level of the container. As mentioned above, the kernel supports a background cache management process, but this process is global and is not customizable for individual containers. By contrast, the improved temporary file system disclosed herein supports local memory swapping that can be applied to individual containers and can be configured individually. In some embodiments, the temporary file system may be a tmpfs file system that has been extended to support the local memory swapping techniques disclosed herein. As described further below, the temporary file system may be used as the upper layer for a container overlay mount.

In some embodiments, one or more swap files may be specified when the temporary file system is mounted and created in a non-volatile storage device. During the building of the container, out-of-memory data can be written to the specified swap file if the container's memory usage reaches the maximum allowed size. In some cases, the total memory usage of the temporary file system will be low enough that all file system data is able to be kept in the container's volatile memory and no storage-related IO occurs. However, if a memory limit is reached, data is written to the swap file and the build process is able to continue. If a swap does occur, the user or process that initiated the file system mount can control which storage device receives the data.

In some embodiments, one or more memory limits (e.g., swap ratios) may be specified at mount time to provide additional control over when memory is written to the swap files. These memory limits can also be used to emulate quota support for unprivileged users. In many cases, it may be desirable to limit the amount of volatile memory or storage space that can be consumed by a container. Such limits can be imposed on the container size by privileged users such as system administrators, but such quotas apply to all of the containers in the cluster and cannot be changes by unprivileged users. However, the memory swapping functionality of the new temporary file system disclosed herein may enable unprivileged users to emulate quotas that can be tailored for specific containers, individually. For example, users can specify hard memory limits that cause additional writes to the container's volatile memory to be blocked once the file system's memory usage reaches the hard memory limit. Other types of quotas may also be emulated. As described more fully further below, extending the temporary file system to support local memory swapping provides more flexible control over the memory swapping mechanisms that effect the container. It also allows container configurations to be more individualized and enables unprivileged users to access container configuration capabilities that are traditionally only accessible to privileged users.

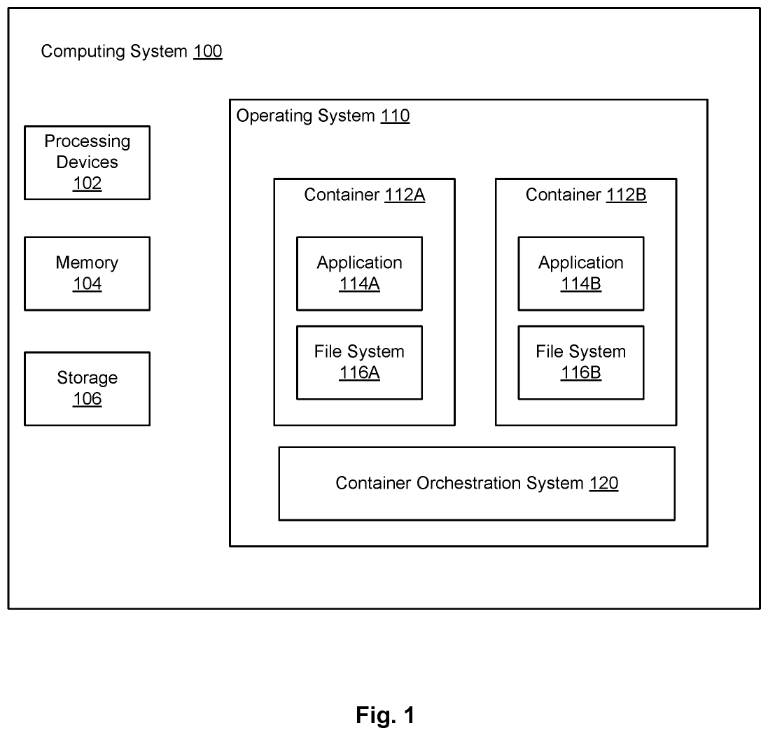

FIG. 1 is a block diagram that illustrates an example computing system architecture, in accordance with some embodiments of the present disclosure. The computing system 100 includes a processing device 102, a memory 104, and storage 106. The computing system 100 may be any data processing device, such as a desktop computer, a laptop computer, a mainframe computer, a rack-mount server, and others. In some embodiments, the computing system 100 may be a computing cluster implemented in a cloud computing platform. Resources of the computing system 100 may be provisioned to clients using platform as a service (PaaS) model.

The computing system 110 may include processing devices 102, memory 104, and storage 106. The processing devices 102 may also include one or more special-purpose processing devices such as an application specific integrated circuit (ASIC), a field programmable gate array (FPGA), a digital signal processor (DSP), network processor, or the like. The processing devices 102 may include complex instruction set computing (CISC) microprocessors, reduced instruction set computing (RISC) microprocessors, very long instruction word (VLIW) microprocessors, or processors implementing other instruction sets or processors implementing a combination of instruction sets.

The memory 104 may include volatile memory devices (e.g., random access memory (RAM)), non-volatile memory devices (e.g., flash memory) and/or other types of memory devices. Storage 106 may be one or more magnetic hard disk drives, a Peripheral Component Interconnect (PCI) solid state drive, a Redundant Array of Independent Disks (RAID) system, a network attached storage (NAS array), etc.

The computing system 100 further includes an operating system 110, which may include a container orchestration system 120 running on the operating system 110. The container orchestration system 120 may initiate, build, and manage one or more containers 112A-B. Container orchestration system 120 may mount file systems 116A-B required by each of the containers 112A-B at the time of building the containers 112A-B. In one example, containers 112A-B may include applications 114A-B to be executed within the containers 112A-B. The container orchestration system 120 may identify file systems required for operation of applications 112A-B and mount the required file systems 116A-B (i.e., provide access to the required file systems) to the containers 112A-B. Users may be able to communicate with the container orchestration system 120 to facilitate management of the computing system 100 and instantiate and manage containers 112 and container workloads. The applications 114 may include any type of executable program, including operating system files and components of client applications such as databases, Web servers, and other services, functions, and workloads.

The container orchestration system 112 may provide an image-based deployment module for creating containers. In some embodiments, container orchestration system 112 may pull container images from an image repository. The container images contain the instructions needed to build a container. For example, container images may contain the operating system and other executable programs to be run inside the container, as well as instructions for how to build the container and what applications should be executed when the container is built. The container images contain the source code, libraries, dependencies, environment configuration, tools, and other files needed for the applications 114A-B to run. Container images may be defined and created by the client and may determine specific tasks or workloads that should run on the corresponding container 112.

The mounted file system 116 may be a temporary file system (e.g., tmpfs-based file system) with local memory swapping capabilities. As used herein, local memory swapping refers to memory swapping functions that can be tailored to a specific container using local memory-swapping specifications that apply to containers individually. The operating system 110 may also perform separate memory swapping functions, referred to herein as global memory swapping. The term global memory swapping (also referred to herein as background cache management or page caching) is used herein to refer to the memory swapping functions that are performed by the operating system in accordance with global memory-swapping specifications that apply to the system as a whole and are not tailored to specific containers individually. Global memory-swapping specifications may be set, for example, by a privileged user such as a system administrator or cluster administrator. Local memory-swapping specifications may be set by unprivileged users, such as the owners of specific containers and specific workloads.

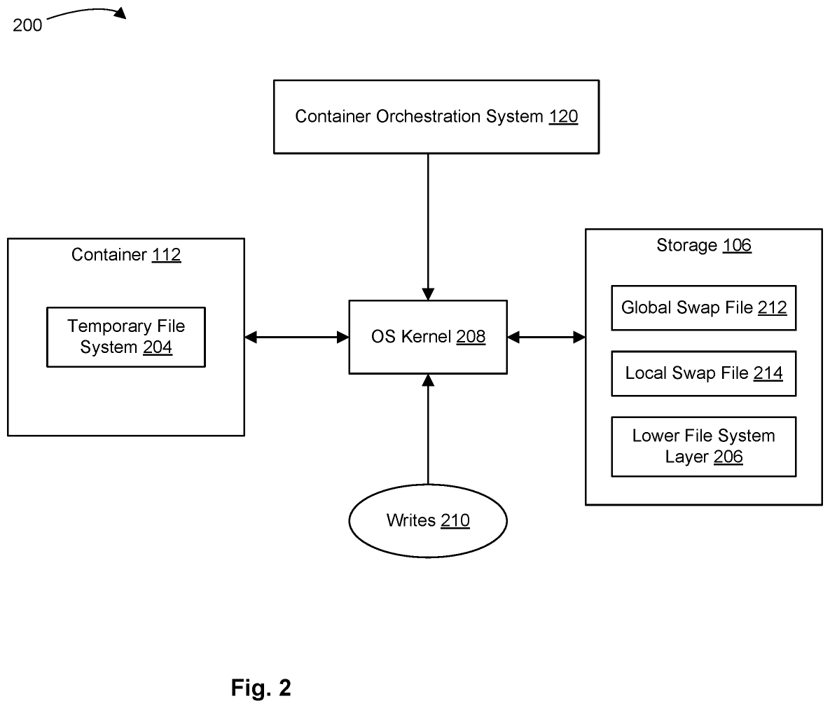

The local memory-swapping specifications may include one or more swap files specifications. The swap file specification identifies a storage file to be used to store the container's system memory and would be additional to any swap file created by the operating system 110 for performing background cache management. In some embodiments, the local memory-swapping specifications can also include memory limits that determine the behavior of the memory swapping function as described further below in relation to FIG. 2. Local memory-swapping specifications may be specified for the mounted file system 116 at mount time and may be specified by unprivileged users.

FIG. 2 illustrates an example system 200 for operating a memory swapping technique with a temporary file system, according to some embodiments of the present disclosure. The example system 200 includes a container 112, storage 106, and the container orchestration system 120. The container 112 may be one of the containers 112A-B described with respect to FIG. 1. Additionally, it will be appreciated that the system 200 can include several additional containers not shown in FIG. 2 for the sake of clarity.

In the example shown in FIG. 2, the container's file system is an overlay file system, sometimes referred to as a union mount file system (e.g., OverlayFS). An overlay file system is one that combines multiple different underlying mount points into one, resulting in single merged directory structure. In this example, the overlay file system combines two file system layers, referred to as an upper file system layer (i.e., temporary file system 204) and a lower file system layer 206. The lower file system layer 206 may be mounted in read-only mode and saved in non-volatile storage 106. Although not shown, the lower file system layer 206 may include multiple lower file system layers. The temporary file system 204 (e.g., tmpfs-based file system) serves as the upper file system layer, which is built on top of the lower file system layer 206 and merged with the lower file system layer 206 during the container build process. The temporary file system 204 is contained in the volatile memory associated with the container 112 and is readable and writeable. It will be appreciated that the present techniques may also be used with other types of file systems and file system configurations, including other types and configurations of overlay mount file systems. For example, in some embodiments, the container's temporary file system 204 may be the entire file system for the container 112.

The system also includes an OS kernel 208, which is a core component of the operating system 110 shown in FIG. 1. The OS kernel 208 acts as a bridge between the container 112 and computing hardware, such as storage 106 and others.

To initiate the building of the container 112, the OS kernel 220 may receive a mount request from the container orchestration system 120, which is a request to mount the overlay mount file system 208. The request may be generated by an automated process running, for example, on the cluster orchestration system 120 or may be generated manually by a human user through a user interface such as a command line interface or others. The mount request may include specifications that describe the configuration of the temporary file system 204 and the lower layer 206. For example, the request may specify that the upper layer is to be a temporary file system (e.g., tmpfs mount) and may also specify a local swap file 214 to associate with the temporary file system 204. The OS kernel 208 may also prepare a global swap file 212 to be used for background cache management. However, the global swap file 212 is generated in accordance with the system-wide background cache processes managed by the OS kernel 208 and is not specified in the mount request.

During the container build process, the OS kernel 208 receives data used to construct the temporary file system 204 within the container 112. For example, data used to construct the temporary file system 204 is received by the OS kernel 208 in the form of writes 210, which contain data to be stored in the volatile memory associated with the container 112.

In some embodiments, the mount request may specify a maximum allowable size for the temporary file system 204. The mount request may also include one or more memory limits, including a soft memory limit (e.g., “background_swap_ratio”) and a hard memory limit (e.g., “swap_ratio”). The soft memory limit and the hard memory limit may be expressed as a ratio of the total amount of memory allocated to the container 112. The soft memory limit specifies a memory usage ratio of the container 112 that will cause the OS kernel 208 to begin swapping container memory from the temporary file system 204 to the local swap file 214 in a background process that executes in parallel with the container build process. If the soft memory limit is triggered, the container 112 can continue to receive writes 210 to the temporary file system 204.

The hard memory limit specifies a memory usage ratio of the container 112 that will cause the OS kernel 208 to continue swapping container memory from the temporary file system 204 to the local swap file 214 and will also cause the OS kernel 208 to block additional writes to the temporary file system 204. If the hard memory limit is reached, writes to the container 112 are blocked until the container's memory usage ratio drops below the hard memory limit.

As stated above, the OS kernel 208 may also implement a background cache management process, which uses the global swap file 212 and is configured as a system-wide process by privileged users such as system administrators. This background cache management process is configured to perform memory swaps for all of the containers supported by the OS kernel 208, including the container 112 and other containers (not shown).

For example, the OS kernel 208 may have a global timeout (e.g., “dirty_expire_centisecs”) that specifies a maximum amount of time that a dirty page will be kept in a container's volatile memory before it is flushed to the underlying storage 106 (e.g., stored to the global swap file 212). Additionally, the OS kernel 208 may have a pair of global dirty-page limits, including a soft dirty-page limit (e.g., “dirty_background_ratio”) and a hard dirty-page limit (e.g., “dirty_ratio”). Both of these may be expressed as a ratio of the total amount of memory allocated to specific containers. The soft dirty-page limit identifies a dirty page ratio (i.e., a percentage of the container memory used by dirty pages) that will cause the OS kernel 208 to begin flushing dirty pages in the background without blocking writes to the container. If the soft dirty-page limit is reached, the effected container can continue to receive writes.

The hard dirty-page limit identifies a dirty page ratio that will cause the OS kernel 208 to continue flushing dirty pages and will also cause the OS kernel 208 to block additional writes to the effected container. If the hard dirty-page limit is reached, writes to the effected container are blocked until the container's dirty page ratio drops below the hard memory limit.

The global timeout, soft dirty-page limit, and hard dirty-page limit cannot not be set differently for different containers. For example, increasing the global timeout would effect all containers equally. Accordingly, if the container 112 had a writable file system residing in storage 106, these global cache management operations would also be applied to the container 112 during the build process, potentially resulting in wasted IO operations. Attempting to reduce the amount of IO for the container 112 by changing these settings (for example, increasing global timeout) may have a deleterious effect on other containers that may be relying on background cache management. However, since the temporary file system 204 is saved only to volatile memory as opposed to non-volatile storage 106, the temporary file system 204 will not accumulate dirty pages and will, therefore, not be effected by the background cache management operations performed by the OS kernel 208. Additionally, the lower file system layer 206 will not accumulate dirty pages, if it has been mounted as a read-only file system. In this way, memory swaps caused by the global cache management can be eliminated, while the memory swaps performed in accordance with the local memory swap specifications specific to the container 112 may be triggered to prevent an out-of-memory error. Additionally, the local memory swap specifications can be controlled by unprivileged users, which provides several advantages such as enabling container owners additional control over the location of the swap files.

Additionally, since the local memory swap specifications can be controlled by unprivileged users, they can also be used to enable unprivileged users to emulate quota support for individual containers. Quotas can be used in clustered computing systems to limit the total amount of compute resources and storage that may be consumed by containers in a cluster. However, such quotas are set by privileged users and are applied to all of the containers in the cluster.

In embodiments of the present techniques, quota support can be emulated for individual containers by specifying suitable memory limits in the mount request for the container 112. The maximum amount of volatile container memory used by the temporary file system 204 can be controlled by specifying suitable values for the maximum allowable size of the temporary file system and the hard memory limit (e.g., “swap_ratio”). For example, if the mount request specifies a maximum allowable size of 10 Gigabytes, and a hard memory limit of 20 percent, this will limit the amount of non-volatile storage usage to 10 Gigabytes and will also limit the amount of volatile container memory usage to 2 Gigabytes.

In another example, the mount request could specify a maximum allowable size of 5 Gigabytes and a hard memory limit of 0 percent. In this example, the size of the temporary file system 204 will be limited to 5 Gigabytes, but all the file system data will reside in the local swap file 214 since all writes to the temporary file system 204 in the volatile container memory will be blocked. This strategy may be useful if the user does not want the behavior of a temporary file system but wants to impose a lower size limit for the file system of this particular container 112 compared to the quota set by the cluster administrator.

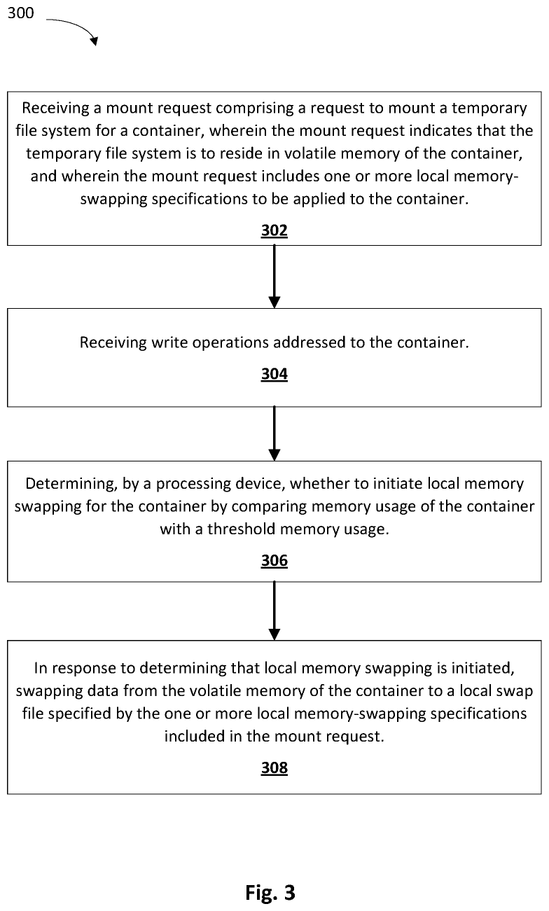

FIG. 3 is a flow diagram summarizing a method 300 of operating a memory swapping technique for a temporary file system, in accordance with some embodiments of the present disclosure. The method 300 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of the method 300 may be performed by an operating system such as the operating system 100 of FIG. 1 and/or the OS kernel 208 of FIG. 2.

With reference to FIG. 3, method 300 illustrates example functions used by various embodiments. Although specific function blocks are shown in method 300, such blocks are examples. That is, embodiments are well suited to performing various other blocks or variations of the blocks recited in method 300. It is appreciated that the blocks in method 300 may be performed in an order different than presented, and that some the blocks in method 300 may be eliminated.

At block 302, a mount request is received which includes a request to mount a temporary file system for a container, wherein the mount request indicates that the temporary file system is to reside in volatile memory of the container and includes one or more local memory-swapping specifications to be applied to the container. The temporary file system may be an upper layer of an overlay file system that also includes a lower layer that resides in non-volatile storage and is mounted in a ready-only mode. The mount request may be received by an OS kernel that mounts the temporary file system for the container in response to the request. The container may be a member of a container cluster that includes a plurality of containers associated with the OS kernel. The local memory-swapping specifications may be specified by an unprivileged user account, i.e., a user account that is authorized to configure containers and container workloads but does not have administrative privileges to the system hosting the container. Additionally, the local memory-swapping specifications may be specified for each of the plurality of additional containers, individually

At block 304, write operations addressed to the container are received. The write operations may be received by the OS kernel, which can transfer the data associated write operation to the volatile memory of the container.

At block 306, a processing device determines whether to initiate local memory swapping for the container by comparing memory usage of the container with a threshold memory usage. The threshold memory usage may be specified by the local memory-swapping specifications and may be a soft memory limit (non-blocking), or a hard memory limit (blocking).

At block 308, in response to determining that local memory swapping is to be initiated, data is swapped from the volatile memory of the container to a local swap file specified by the one or more local memory-swapping specifications included in the mount request. If the hard memory limit has been reached, writes addressed to the container are blocked while swapping data from the volatile memory of the container to the local swap file. The OS kernel may also be configured to perform a background cache management process in accordance with a set of global memory-swapping specifications that apply to all of the containers in the cluster.

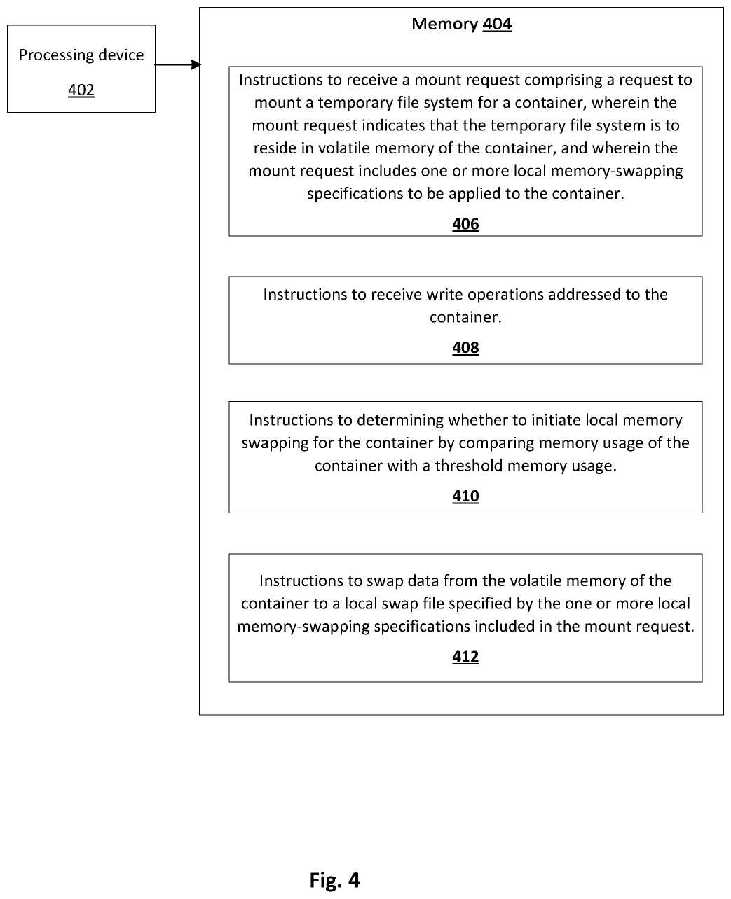

FIG. 4 is a block diagram of a system for operating a memory swapping technique for a temporary file system, in accordance with some embodiments of the present disclosure. The system 400 includes a processing device 402 operatively coupled to a memory 404. The memory 404 includes instructions that are executable by the processing device 402 to cause the processing device 402 to build a container with a temporary file system configured for local memory swapping, in accordance with some embodiments of the present disclosure.

The memory 404 includes instructions 406 to receive a mount request comprising a request to mount a temporary file system for a container, wherein the mount request indicates that the temporary file system is to reside in volatile memory of the container, and wherein the mount request includes one or more local memory-swapping specifications to be applied to the container. The memory 404 also includes instructions 408 to receive write operations addressed to the container. The memory 404 also includes instructions 410 to determine whether to initiate local memory swapping for the container based on a comparison of memory usage of the container with a threshold memory usage. The memory 404 also includes instructions 412 to, in response to determining that local memory swapping is initiated, swap data from the volatile memory of the container to a local swap file specified by the one or more local memory-swapping specifications included in the mount request.

It will be appreciated that various alterations may be made to the process illustrated in FIG. 4 and that some components and processes may be omitted or added without departing from the scope of the disclosure.

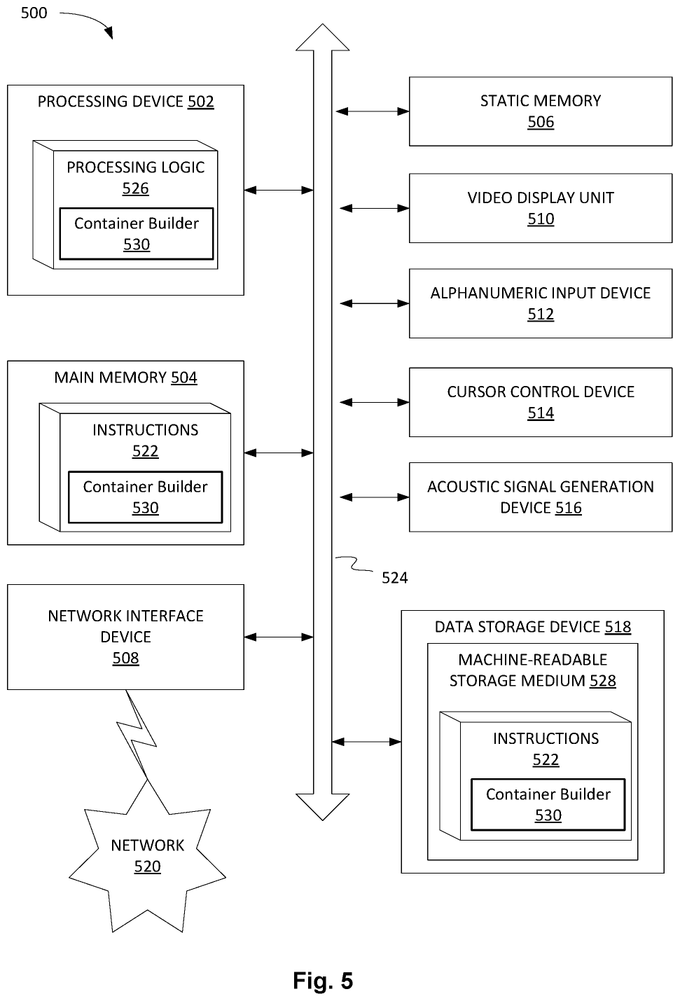

FIG. 5 is a block diagram of an example computing device 500 that may perform one or more of the operations described herein, in accordance with some embodiments of the present disclosure. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a server, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory) and a data storage device 518, which may communicate with each other via a bus 524.

Processing device 502 may be provided by one or more general-purpose processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions 522 that may include a container builder 530 comprising instructions for carrying out the operations described herein, in accordance with one or more aspects of the present disclosure. The container builder 530 may also reside, completely or at least partially, within main memory 504 and/or within processing device 502 (e.g., within processing logic 526) during execution thereof by computing device 500, main memory 504 and processing device 502 also constituting computer-readable media. The container builder 530 may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “sending,” “receiving,” “establishing,” “determining,” “comparing,” “generating,” “transferring,” “swapping,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the techniques to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the disclosure is not to be limited to the details given herein, but may be modified within the scope and equivalents of the appended claims.

What is claimed is:

1. A method comprising:
receiving a mount request comprising a request to mount a temporary file system for a container, wherein the mount request indicates that the temporary file system is to reside in volatile memory of the container, and wherein the mount request includes one or more local memory-swapping specifications to be applied to the container;
receiving write operations addressed to the container;
determining, by a processing device, whether to initiate local memory swapping for the container by comparing memory usage of the container with a threshold memory usage; and
in response to determining that local memory swapping is initiated, swapping data from the volatile memory of the container to a local swap file specified by the one or more local memory-swapping specifications included in the mount request.

2. The method of claim 1, wherein the container is a member of a container cluster comprising the container and a plurality of additional containers, and wherein additional local memory-swapping specifications are specified for each of the plurality of additional containers individually.

3. The method of claim 1, wherein determining whether to initiate local memory swapping for the container is performed by an OS kernel, and wherein the OS kernel is to perform a background cache management process in accordance with a set of global memory-swapping specifications.

4. The method of claim 1, wherein the one or more local memory-swapping specifications are specified by an unprivileged user account.

5. The method of claim 1, wherein the threshold memory usage is a soft memory limit specified by the one or more local memory-swapping specifications included in the mount request, and wherein the write operations addressed to the container are allowed while swapping data from the volatile memory of the container to the local swap file.

6. The method of claim 1, wherein the threshold memory usage is a hard memory limit specified by the one or more local memory-swapping specifications included in the mount request, and wherein the write operations addressed to the container are blocked while swapping data from the volatile memory of the container to the local swap file.

7. The method of claim 1, wherein the temporary file system is an upper layer of an overlay file system, wherein the overlay file system further includes a lower layer that resides in non-volatile storage and is mounted in a ready-only mode.

8. A system comprising:
a memory; and
a processing device operatively coupled to the memory, the processing device to:
receive a mount request comprising a request to mount a temporary file system for a container, wherein the mount request indicates that the temporary file system is to reside in volatile memory of the container, and wherein the mount request includes one or more local memory-swapping specifications to be applied to the container;
receive write operations addressed to the container;
determine whether to initiate local memory swapping for the container based on a comparison of memory usage of the container with a threshold memory usage; and
in response to determining that local memory swapping is initiated, swap data from the volatile memory of the container to a local swap file specified by the one or more local memory-swapping specifications included in the mount request.

9. The system of claim 8, wherein the container is a member of a container cluster comprising the container and a plurality of additional containers, and wherein additional local memory-swapping specifications are specified for each of the plurality of additional containers individually.

10. The system of claim 8, wherein the determination to initiate local memory swapping is performed by an OS kernel executing on the processing device, and wherein the OS kernel is configured to perform a background cache management process in accordance with a set of global memory-swapping specifications.

11. The system of claim 8, wherein the one or more local memory-swapping specifications are specified by an unprivileged user account.

12. The system of claim 8, wherein the threshold memory usage is a soft memory limit specified by the one or more local memory-swapping specifications included in the mount request, and wherein the write operations addressed to the container are allowed while data is swapped from the volatile memory of the container to the local swap file.

13. The system of claim 8, wherein the threshold memory usage is a hard memory limit specified by the one or more local memory-swapping specifications included in the mount request, and wherein the write operations addressed to the container are blocked while data is swapped from the volatile memory of the container to the local swap file.

14. The system of claim 8, wherein the temporary file system is an upper layer of an overlay file system, wherein the overlay file system further includes a lower layer that resides in non-volatile storage and is mounted in a ready-only mode.

15. A non-transitory computer-readable storage medium including instructions that, when executed by a processing device, cause the processing device to:
receive a mount request comprising a request to mount a temporary file system for a container, wherein the mount request indicates that the temporary file system is to reside in volatile memory of the container, and wherein the mount request includes one or more local memory-swapping specifications to be applied to the container;
receive write operations addressed to the container;
determine, by the processing device, whether to initiate local memory swapping for the container based on a comparison of memory usage of the container with a threshold memory usage; and
in response to determining that local memory swapping is initiated, swap data from the volatile memory of the container to a local swap file specified by the one or more local memory-swapping specifications included in the mount request.

16. The non-transitory computer-readable storage medium of claim 15, wherein the container is a member of a container cluster comprising the container and a plurality of additional containers, and wherein additional local memory-swapping specifications are specified for each of the plurality of additional containers individually.

17. The non-transitory computer-readable storage medium of claim 15, wherein the determination to initiate local memory swapping is performed by an OS kernel executing on the processing device, and wherein the OS kernel is to perform a background cache management process in accordance with a set of global memory-swapping specifications.

18. The non-transitory computer-readable storage medium of claim 15, wherein the one or more local memory-swapping specifications are specified by an unprivileged user account.

19. The non-transitory computer-readable storage medium of claim 15, wherein the threshold memory usage is a soft memory limit specified by the one or more local memory-swapping specifications included in the mount request, and wherein the write operations addressed to the container are allowed while data is swapped from the volatile memory of the container to the local swap file.

20. The non-transitory computer-readable storage medium of claim 15, wherein the threshold memory usage is a hard memory limit specified by the one or more local memory-swapping specifications included in the mount request, and wherein the write operations addressed to the container are blocked while data is swapped from the volatile memory of the container to the local swap file.
